(19) United States
(12) Patent Application Publication
(10) Pub. No.: US 2007/0024888 A1
(43) Pub. Date: Feb. 1, 2007

(54) Protecting valuable media

(76) Inventors: Eliot N. Bailey, Boise, ID (US); Daniel T. Lay, Horseshoe Bend, ID (US); Erica N. Saxton, Boise, ID (US); Marty L. Dixon, Nampa, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/190,428

(22) Filed: Jul. 27, 2005

(51) Int. Cl. G06K 15/00

(52) U.S. Cl. 358/1.14

(57) ABSTRACT

A system and methods enable the protection of valuable media from theft or other improper access by people who might use the media for dishonest, illegitimate, or criminal purposes. An evaluation of a print job results in a determination regarding whether the print job is suspected of being an attempt to improperly access blank, valuable media. A suspect print job can be stopped or canceled, and a message can be sent which notifies an appropriate administrator of the possibility that an illegitimate attempt has been made to acquire blank, valuable media.

### BACKGROUND

Corporations often have valuable media that they need to protect from people who might try to acquire it and use it for dishonest, illegitimate, or even criminal purposes. For example, an unauthorized employee or company outsider might want to acquire blank, expensive, company letterhead to use for illegitimate purposes that are not consistent with a company's policies or goals. Companies also typically have financial media such as blank checks that need protection from unscrupulous people who might dare to write unauthorized checks against a company's financial accounts. Therefore, protecting blank, valuable media is an important issue for many companies.

Making valuable media available to those who would use it properly while at the same time protecting it from those who would use it improperly can be a challenging problem. For example, such media is typically stored temporarily in a media tray of a printing device prior to being printed and output from the printer for legitimate company purposes. Current methods for protecting such valuable media from illegitimate uses involve physically locking the media trays in which the media is stored so that an unscrupulous user is not able to merely open the tray and remove the blank media. Unfortunately, this solution relies on a manager or other authorized person to control the valuable media inventory under a lock and key.

Moreover, while physically locking valuable media into a media tray can protect against a user simply opening the media tray and removing the media, there are other ways for users to illicitly acquire the media in its blank or unused form. For example, an employee or outsider breaking into a company system might be able to send print jobs to a printer that are formatted such that one or more blank copies of valuable media are output from the printer. In this scenario, a locked media tray would not prevent the unauthorized access to valuable media.

### BRIEF DESCRIPTION OF THE DRAWINGS

The same reference numerals are used throughout the drawings to reference like components and features.

FIG. 1 illustrates an exemplary embodiment of an environment that is suitable for protecting valuable media.

FIG. 2 illustrates exemplary embodiments of a host computer and a printing device that are suitable for protecting valuable media.

FIG. 3 illustrates an exemplary embodiment of a data matrix that includes information useful in print job comparisons.

FIGS. 4-5 are flow diagrams illustrating exemplary embodiments of methods for protecting valuable media.

### DETAILED DESCRIPTION

Introduction

The following discussion is directed to a system and methods for protecting valuable media from theft or other improper access by people who might use the media for dishonest, illegitimate, or criminal purposes. In general, an evaluation of attributes and contents of a print job results in a determination regarding whether the print job is suspected of being an attempt to improperly access blank media (or effectively blank media) of a cost sensitive and/or proprietary nature. A suspect print job can be stopped or canceled, and a message can be sent which notifies an appropriate administrator of the possibility that an illegitimate attempt has been made to acquire blank, valuable media.

In one embodiment an evaluation includes a determination of whether the target media of a print job is valuable media. If the target media is valuable media, the evaluation further includes a comparison to determine if the application program that originated the print job is on a pre-determined list of applications approved for printing to valuable media (e.g., as defined by a system administrator).

In one embodiment, an evaluation includes a determination of whether a print job is empty or devoid of printable data. If the print job is not empty or devoid of printable data, the evaluation further includes a comparison of the amount of printable data in the print job to a minimally sufficient amount of printable data (e.g., as defined by a system administrator) that is associated with the approved application that originated the print job.

In another embodiment, an evaluation includes a determination of whether completion of the print job will result in sufficient marking agent being applied to the target media. This determination includes determining whether some of the print data in the print job is being printed in white font. If so, the determination further includes determining if all the print data in the print job is being printed in white font. If only some of the print data in the print job is being printed in white font, the determination further includes determining whether a minimum pixel count or ink dot count is met by the print job (e.g., as defined by a system administrator).

In different embodiments, the evaluations can be performed on a host computer device associated with a printer, or on the printer itself.

Exemplary Environment

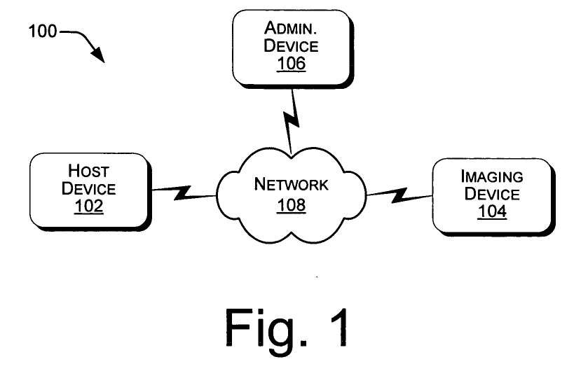

FIG. 1 illustrates an exemplary embodiment of an environment 100 that is suitable for protecting valuable media such as blank checks, company letterhead, and other cost sensitive and proprietary media.

The environment 100 includes a host computing device 102, an image forming device 104, an administrative computing device 106, and a communication network 108 operatively coupling the host device 102, the imaging device 104, and the administrative device 106. Network 108 can include both local and remote connections and is intended to represent any of a variety of conventional network topologies and types (including optical, wired and/or wireless networks), employing any of a variety of conventional network protocols (including public and/or proprietary protocols). Thus, network 108 may include, for example, any one or a combination of a modem, a cable modem, a LAN (local area network), a WAN (wide area network), an intranet, the Internet, a USB cable, a printer cable, or any other suitable communication link.

Host computing device 102 generally provides a user with the ability to manipulate or otherwise prepare in electronic form such as a print job, an image or document to be rendered as an image that is printed or otherwise formed onto a print medium by imaging device 104 after transmission over network 108. As discussed more fully below, in one embodiment host device 102 also evaluates print jobs based on various criteria related to protecting valuable print media to determine whether to stop or cancel print jobs. Host device 102 is otherwise typically capable of performing common computing functions, such as email, calendaring, task organization, word processing, Web browsing, and so on. In this embodiment, host device 102 runs an open platform operating system, such as the Windows® brand operating systems from Microsoft®. Host device 102 may be implemented, for example, as any of a variety of conventional computing devices, including desktop personal computers (PCs), notebook or portable computers, workstations, mainframe computers, Internet appliances, print servers, handheld PCs, combinations thereof, and so on.

Administrative device 106 can be implemented in a manner similar to that discussed above regarding host device 102. In fact, administrative device 106 and host device 102 may in one embodiment, be the same device. Thus, the separate illustration of administrative device 106 in FIG. 1 is provided in order to facilitate this description and is not necessarily intended to indicate that host device 102 and administrative device 106 are not the same device. In general, administrative device 106 supports an administrative user and facilitates a reporting mechanism by which host device 102 or image forming device 104 can report a suspect print job that indicates a possible attempt by a user to illicitly acquire valuable print media.

Imaging device 104 is often directly peripheral to a general purpose host device 102 (e.g., via network 108 implemented as a USB cable, etc.), but it can also be a stand-alone device remotely coupled to a host device 102 (e.g., via network 108 implemented as an intranet, etc.). One exemplary embodiment of an imaging device 104 is a printer such as a laser printer, an inkjet printer, a dot matrix printer, a dry medium printer, a plotter and the like. Other examples of imaging devices 104 include facsimile machines, copiers, scanners and multifunction peripheral (MFP) devices which combine the functionality of two or more peripheral devices into a single device. Throughout the remainder of this description, imaging device 104 will be referred to as a printing device 104.

In general, printing device 104 receives an image as a print job transmitted by a host device 102 over network 108. Printing device 104 is configured to render the image as a hard copy image document formed on various print media including, for example, paper, transparencies, glossy photo paper, envelopes, labels and the like. As discussed more fully below, in one embodiment, prior to rendering an image onto print media, printing device 104 evaluates the print job based on various criteria related to protecting valuable print media to determine whether to stop or cancel the print job.

### Exemplary Embodiments

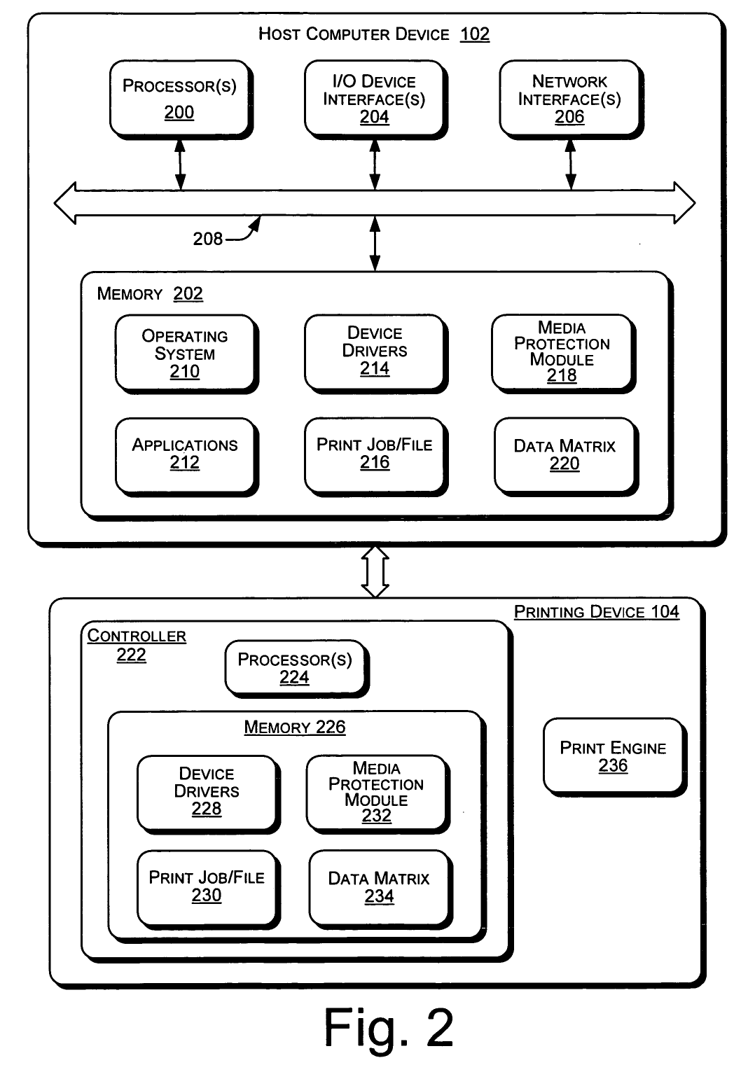

FIG. 2 illustrates in greater detail, exemplary embodiments of a host computer device 102 and a printing device 104 suitable for protecting valuable media such as blank checks, company letterhead, and other cost sensitive and proprietary media. Various components that enable the protection of valuable media are shown in FIG. 2 as residing on both the host computer 102 and the printing device 104. As will become apparent from the following description, this illustration is not intended to indicate that such components are required to reside on both the host computer 102 and the printing device 104. Rather, this merely demonstrates that in different embodiments, either one or both of the host computer 102 and printing device 104 may be configured to enable the protection of valuable media as discussed herein. Furthermore, while one exemplary host computer device 102 and one exemplary printing device 104 are described herein for purposes of illustration, it should be noted that protecting valuable print media as discussed herein is not limited to implementation on these particular devices, but that many other devices are possible.

Generally, host computer device 102 may include a processor 200, a memory 202, input/output device interface(s) 204, and network interface(s) 206 that are communicatively coupled via a system bus 208. The system bus 208 may be any of several types of bus structures, including wired or wireless connections, and may comprise multiple bus structures interconnected by various bridges, adapters and/or controllers.

The processor 200 is a hardware device for executing software that can be stored in the memory 202. The processor 200 can be any custom-made or commercially available processor, including a central processing unit (CPU), an auxiliary processor among several processors associated with the host computer 102, or a semiconductor-based microprocessor (in the form of a microchip). When the host computer 102 is in operation, the processor 200 is configured to execute software stored within the memory 202, to communicate data to and from the memory 202, and to generally control operations of the host computer 102.

The memory 202 can include any one or combination of volatile memory elements (e.g., random access memory (RAM, such as dynamic RAM or DRAM, static RAM or SRAM, etc.)) and nonvolatile memory elements (e.g., read-only memory (ROM), hard drives, tape drives, compact discs (CD-ROM), floppy discs, etc.). Moreover, the memory 202 may incorporate electronic, magnetic, optical, and/or other types of storage media now known or later developed. Note that the memory 202 can have a distributed architecture, where various components are situated remote from one another, but can be accessed by processor 200.

The memory 202 may contain data files and several software application programs, each of which typically comprises an ordered listing of executable instructions for implementing logical functions. In the illustrated example, the data files and software in the memory 202 include an operating system 210, one or more software applications 212, a device driver 214, a print job/file 216, a media protection module 218, and a data matrix 220. The operating system 210 generally controls the execution of applications 212 and provides, for example, scheduling, input-output control, file and data management, memory management, and communication control and related services.

The input/output device interface(s) 204 may include one or more of a number of device interfaces for communicating via various devices, such as but not limited to, a keyboard, a mouse or other suitable pointing device, a microphone, a scanner, etc. Furthermore, the input/output device interface(s) 204 may also include known or later developed output devices, for example but not limited to, a printer, a monitor, an external speaker, etc. The network interface(s) 206 may include a host of devices capable of establishing communication sessions between the host computer 102 and network 108. Thus, the network interface(s) 206 may include but are not limited to, a modem (for accessing another device, system, or network), a radio frequency (RF) or other transceiver, a telephonic interface, a bridge, an optical interface, a router, and so on.

As used herein, the term “computer-readable medium” refers generally to any medium or means that can store, communicate, propagate, and/or transport a program for use by or in connection with a computer or similar system, apparatus, or device. The computer-readable medium can be, for example, but is not limited to, an electronic, magnetic, optical, electromagnetic, infrared, or semiconductor system, apparatus, device, or propagation medium now known or later developed. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Applications 212, media protection module 218, and other software can be embodied in any computer-readable medium for use by host computer 102. This can be accomplished, for example, by downloading the software onto an internal memory element (such as a hard disk or integrated circuit memory device) of host computer 102 from a removable computer-readable medium (such as a floppy disk, CD-ROM, or the like) or from a remote computer system over the Internet or other computer network via the network interface(s) 206. Such software may also reside on a removable computer-readable medium inserted into an appropriate drive of host computer 102 and be accessed from that drive. In this case, for example, an application 212 could be accessed directly from the removable computer-readable medium, instead of being transferred to an internal memory element. As an alternative to being contained in the memory 202, software such as applications 212 and media protection module 218 could reside on a remote computer system and be accessed by host computer 102 over network 108 via the network interface(s) 206.

One or more of the software applications 212 stored in memory 204 and executable on processor 200 may create a document or image (text and graphics) on a computer screen that is transferable as a print job 216 to printing device 104 for creating a hard copy of the document/image. Such applications 212 might include software programs implementing word processors, financial accounting applications, illustrators, computer-aided design tools and the like. One or more software-based device drivers 214 may be configured to format document data generated by an application 212 into a print job 216 having print data formatted in a page description language (PDL) such as PostScript, printer control language (PCL), or another appropriate format prior to outputting the print job 216 to printing device 104. Although device drivers 214 are typically implemented on a host device such as host computing device 102, they can also be implemented on the specific device they are “driving”, such as printing device 104.

Media protection module 218 is generally configured to evaluate print jobs 216 prior to their being rendered by printing device 104, and to determine whether the print jobs 216 are suspected of being used illicitly to gain improper access to valuable blank media (or effectively blank media), such as cost sensitive and/or proprietary media. For example, a user (authorized or not authorized) may compose a document on host computer 102 (e.g., using an application 212) for the ostensible purpose of printing legitimate output onto valuable media, such as blank company checks or letterhead. However, the user's true purpose may be to compose the document such that the resulting print job 216 causes a printing device 104 to output valuable media from a locked media tray while printing effectively nothing onto the valuable media. This could be accomplished, for example, by having no printable data in the print job 216 (i.e., an empty print file), by printing all printable data in the print job 216 in a white font that would not appear on the media, or by ensuring that printable data in the print job 216 prints to locations on the media that would render the printed data unnoticeable to the casual observer (e.g., by printing a line directly over a pre-existing line on the media). The result of such a devious effort may be a stack of valuable blank media waiting in the output tray of printing device 104 as a reward for a wayward user whose true purpose is to steal the valuable media.

Media protection module 218 is configured to protect against such situations by evaluating print jobs 216 and detecting those jobs that are suspect. Upon detecting a suspect print job 216, media protection module 218 can stop or cancel the print job 216. Media protection module 218 can also generate and send a notification to a proper authority such as an administrator associated with administrative device 106. Such a notification message notifies the appropriate administrative authority that a possible illegitimate attempt has been made to acquire blank, valuable media. The notification may include relevant information such as the date and time of the suspect print job, an identification of the host computer 102 from which the print job 216 originated, a user identification for a user associated with the host computer 102, a printing device identification identifying the printing device 104 for which the suspect print job was destined, and so on.

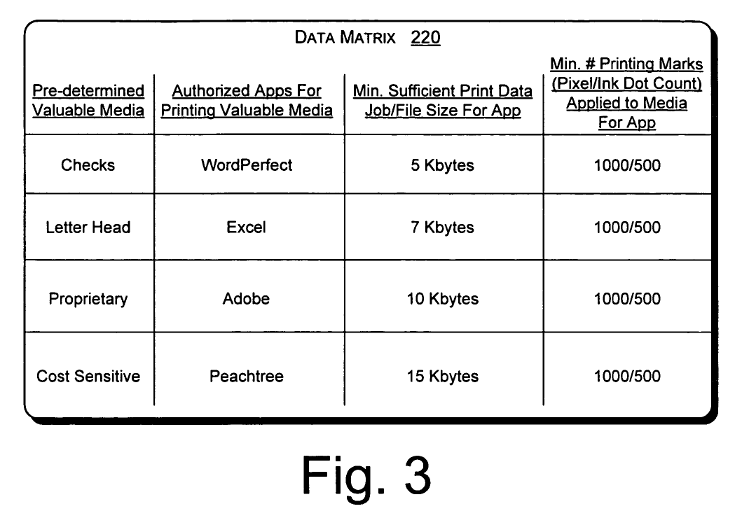

In different embodiments, media protection module 218 is enabled to perform various evaluations of print jobs 216 to determine which print jobs may be suspected of being used illicitly to gain improper access to valuable blank media. A data matrix 220 is used to facilitate a variety of comparisons that are made during certain evaluations by media protection module 218. Data matrix 220 thus includes particular pre-determined information that is useful to the media protection module 218 for making certain data/information comparisons when evaluating print jobs 216. FIG. 3 illustrates an exemplary embodiment of a data matrix 220 that includes particular pre-determined information useful in certain comparisons performed by media protection module 218.

As shown in FIG. 3, one embodiment of data matrix 220 includes a list of pre-determined valuable media types, a list of applications 212 authorized for printing to valuable media, the minimum sufficient amount of print data (i.e., minimum print job/file size) for corresponding applications 212, and the minimum number of printing marks (e.g., minimum pixel count, minimum ink dot count) to be applied to the target/valuable media for corresponding applications 212. The pre-determined valuable media types listed in the exemplary data matrix 220 of FIG. 3 include checks, company letter head, other proprietary media, and other cost sensitive media. It is noted that the valuable media could be virtually any type of media deemed valuable by an appropriate administrator, and that the list shown in data matrix 220 of FIG. 3 is provided by way of example only and not by way of limitation. As discussed in more detail below, one comparison made by the media protection module 218 uses the list of valuable media in the data matrix 220 to determine if the target media of a print job 216 is valuable media.

The list of authorized applications for printing to valuable media shown in the exemplary data matrix 220 of FIG. 3 includes WordPerfect, Excel, Adobe, and Peachtree accounting software applications. Similar to the valuable media just discussed above, the authorized applications listed in the data matrix 220 could be virtually any software application 212 deemed to be approved for printing to valuable media by an appropriate administrator. This list could also include custom applications. By virtue of his/her access to and control over the authorized applications list, the administrator (e.g., from admin. device 106) can control which applications can print to valuable media. Conversely, since only approved applications can print to valuable media, the administrator also can eliminate the possibility of other non-applications or non-PDL sources printing to valuable media. Thus, the list provided in FIG. 3 is shown by way of example only and not by way of limitation. As discussed in more detail below, one comparison made by the media protection module 218 uses the list of authorized applications in the data matrix 220 to determine if a print job 216 has been originated by an application that is authorized for printing to valuable media.

The minimum sufficient amount of print data for a corresponding application, as shown in FIG. 3, indicates a minimum acceptable file size for a print job (i.e., the minimum print file size) originating from a particular application. Thus, in the exemplary data matrix 220 of FIG. 3, the minimum sufficient print data amount or print job file size for a print job originating from the WordPerfect application, for example, is 5 Kbytes in size (or 5 Kbytes of print data). The minimum sufficient amounts of print data or file sizes for a given software application 212 as shown in data matrix 220 are definable by a system administrator. Therefore, these amounts can be altered by an administrator, for example, to adapt to changing tactics a user might use for attempting to gain access to valuable media. It is noted that the numbers provided for the minimum sufficient data or print file size in FIG. 3 are merely examples, and are not necessarily intended to be actual numbers that may be useful in a data matrix 220. Thus, actual numbers for the listed software applications may differ substantially from those shown in FIG. 3. As discussed in more detail below, one comparison made by the media protection module 218 uses the minimum sufficient print job/file size for an application as shown in the data matrix 220 to determine if a print job 216 contains enough print data to be considered a legitimate job for printing to valuable media.

The minimum number of printing marks to be applied to the target/valuable media for a corresponding application as shown in the exemplary data matrix 220 of FIG. 3 indicates a minimal acceptable amount of marking agent (e.g., a minimum number of pixels, ink dots, etc.) that needs to be applied to media in order for a print job 216 to be considered a legitimate job for printing to valuable media. Thus, in the exemplary data matrix 220 of FIG. 3, the minimum sufficient pixel count (i.e., if printing device 104 is a laser printer) and ink dot count (i.e., if printing device 104 is an ink dot printer) for a print job originating from the WordPerfect application, for example, is 1000 pixels and 500 ink dots, respectively. It is noted that the numbers provided for the minimum pixel count or ink dot count in FIG. 3 are merely examples, and are not necessarily intended to be actual numbers that may be useful in a data matrix 220. Thus, actual numbers for the listed software applications may differ substantially from those shown in FIG. 3. Furthermore, this description contemplates printing device types other than laser printers and ink dot printers that may have printing marks other than pixels or ink dots. As discussed in more detail below, one comparison made by the media protection module 218 uses the minimum number of printing marks (e.g., pixel count or ink dot count) for an application as shown in the data matrix 220 to determine if the completion of a print job 216 will result in sufficient marking agent being applied to media for the print job 216 to be considered a legitimate job for printing to valuable media.

Referring again to FIG. 2, as noted above, various components that enable the protection of valuable media are shown as residing on both the host computer 102 and the printing device 104 in order to demonstrate that either one or both of the host computer 102 and printing device 104 may be configured to enable the protection of valuable media as discussed herein. Thus, a description of components of printing device 104 of FIG. 2, including device drivers 226, print job 228, media protection module 230, and data matrix 232 would closely parallel the description provided above regarding these same components on the host computer 102. Accordingly, these components will not be described in detail again in the following description of printing device 104.

As shown in the FIG. 2 embodiment, printing device 104 includes a controller 222 for processing data from host computer 102. The controller 222 typically includes a data processing unit or processor 224 and a memory 226. Memory 226 can include any one or combination of volatile memory elements (e.g., random access memory (RAM, such as dynamic RAM or DRAM, static RAM or SRAM, etc.)) and nonvolatile memory elements (e.g., read-only memory (ROM), hard drives, tape drives, compact discs (CD-ROM), floppy discs, etc.). Moreover, the memory 226 may incorporate electronic, magnetic, optical, and/or other types of storage media now known or later developed. Memory 226 generally provides storage of computer readable instructions, data structures, program modules and other data for printing device 104. In one embodiment, the program modules and data files stored in memory 226 include a device driver 228, a print job/file 230, a media protection module 232, and a data matrix 234. The function and operation of these components parallels those already discussed above regarding similar components on host computer 102.

Printing device 104 also includes a print engine 236 that performs the actual printing of a document or forming of an image onto a print medium. Print engine 236 may be, for example, a laser print engine, an ink dot print engine, and so on. The imaging device controller 222 generally processes image/document data from host computer 102 and manages printing device 104 functions by controlling print engine 236.

As noted above regarding the same or similar components of host computer 102, media protection module 232 on printing device 104 is generally configured to evaluate print jobs 230 prior to their being rendered by print engine 236, and to determine whether the print jobs 230 are suspected of being used illicitly to gain improper access to valuable blank media (or effectively blank media), such as cost sensitive and/or proprietary media. Such evaluations can include various comparisons between print job 230 characteristics and pre-determined information stored in data matrix 234.

Exemplary Methods

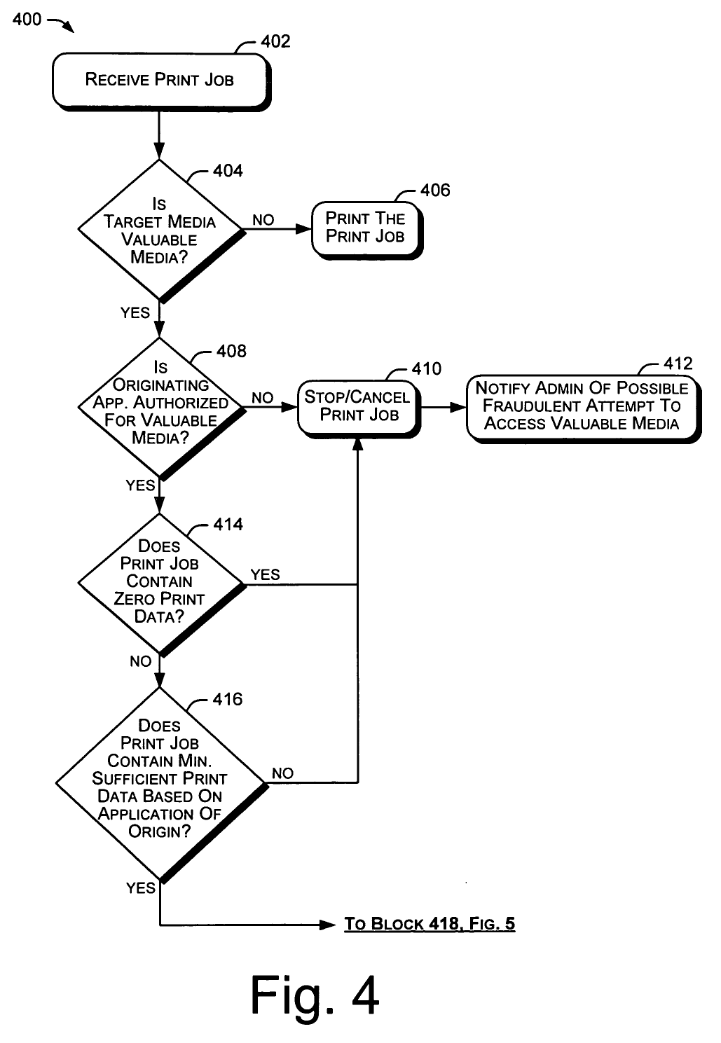

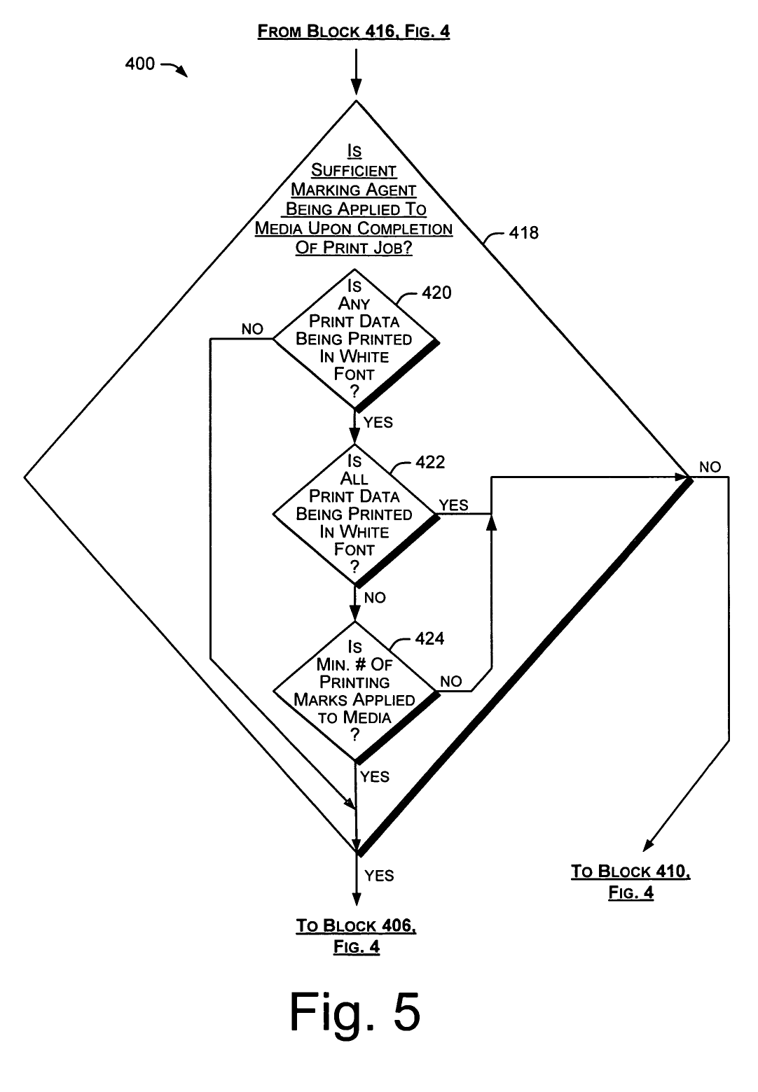

Example methods for protecting valuable media such as blank checks, company letterhead, and other cost sensitive and proprietary media will now be described with primary reference to the flow diagrams of FIGS. 4 and 5. The exemplary methods apply generally to the exemplary embodiments discussed above with respect to FIGS. 1-3. While one or more methods are disclosed by means of flow diagrams and text associated with the blocks of the flow diagrams, it is to be understood that the elements of the described methods do not necessarily have to be performed in the order in which they are presented, and that alternative orders may result in similar advantages. Furthermore, the methods are not exclusive and can be performed alone or in combination with one another. The elements of the described methods may be performed by any appropriate means including, for example, by hardware logic blocks on an ASIC or by the execution of computer-readable instructions defined on a computer-readable medium.

An exemplary method 400 begins at block 402, when a print job is received. The print job is generally originated by an application program 212 on a host computer 102. The print job is received into a memory either on the host computer 102 or a printing device 104 after being formatted by a device driver such as a driver 214 on host computer 102 or driver 228 on printing device 104.

At block 404, a media protection module (e.g., media protection module 218 or 232) determines if the target media to which the print job is to print, is valuable media. As noted above, valuable media can include any type of media pre-designated as valuable media by, for example, an administrative authority. Typically, valuable media includes media such as blank checks, company letterhead, and other cost sensitive and proprietary media. The media protection module parses the print job to identify the target media type and then compares the target media type to a list of pre-designated valuable media types provided in a data matrix, such as data matrix 220 on host computer 102 or data matrix 234 on printing device 104. If the target media type does not match one of the valuable media types, the target media is not valuable media, and the print job is printed on the printing device 104 as shown at block 406.

If the target media is valuable media, the media protection module determines if the application 212 that originated the print job is authorized to print to valuable media. The media protection module parses the print job to identify the originating application and then compares the application to a list of applications in a data matrix that have been pre-determined to be authorized to print to valuable media. If the originating application is not included in the list of authorized applications in the data matrix, then the print job is canceled as shown at block 410. As shown at block 412, when a print job is canceled, a notification can be sent to an administrative authority (e.g., at administrative device 106) to inform the administrator that a possible fraudulent attempt has been made to acquire valuable media. The notification can include information such as the date and time of the suspect/canceled print job, an identification of the host computer 102 from which the print job originated, a user identification for a user associated with the host computer 102, a printing device identification identifying the printing device 104 for which the suspect print job was destined, and so on.

At block 414, if the originating application is found to be an authorized application for printing to valuable media, the media protection module further determines whether there in no printable data in the print job. This can be done, for example, by parsing the print job to search for printable data or by comparing the print job file size to a known file size for an empty print file corresponding with the originating application. Although not shown in the data matrix of FIG. 3, each authorized application may additionally have an associated “empty file size” number indicating the size of a file from that application that would be a blank or empty print file. Also shown at block 414, if the print job is found to contain no print data, the print job is canceled as discussed above regarding blocks 410 and 412.

However, if there is print data in the print job, the media protection module checks to see if the amount of data in the print job meets a minimally sufficient amount of data (or is of a minimally sufficient file size) to be considered a legitimate print job for printing to valuable media, as shown at block 416. The media protection module compares the amount of print data in the print job to a minimally sufficient amount of data listed in the data matrix for the application program that originated the print job. Also as shown at block 416, if the print job does not contain the minimally sufficient amount of print data, the print job is canceled as discussed above regarding blocks 410 and 412.

The method 400 continues at block 418 of FIG. 5. If the print job contains the minimally sufficient amount of print data as determined at block 416, at block 418 the media protection module then determines if a minimally sufficient amount of marking agent will be applied to the valuable media by the print job to conclude that the print job is legitimate for printing to valuable media. This determination can be made in one or more steps. The first step determines if a user is trying to print in a font color that will not appear on the valuable media (i.e., a font color that will not make an apparent mark on the media). Although a white font is discussed, other font colors might also be font colors that would effectively produce no mark on the media depending on the background color of the media. Accordingly, white font is used herein by way of example only and not by way of limitation.

As shown at block 420, the media protection module determines if any print data in the print job is to be printed in a white font. If none of the print data is to be printed in a white font, then the media protection module determines that there will be a minimally sufficient amount of marking agent applied to the valuable media and the print job is printed as shown at block 406. However, from block 420, if any print data in the print job is to be printed in a white font, the media protection module then determines at block 422 if all of the print data in the print job is to be printed in a white font. If all of the print data is to be printed in a white font, the media protection module determines that there is not a minimally sufficient amount of marking agent that will be applied to the valuable media to conclude that the print job is legitimate for printing to valuable media. In this case, the print job would be canceled as discussed above regarding blocks 410 and 412.

However, if all the print data will not be printed in a white font, the media protection module then determines if a minimum number of printing marks will be applied to the valuable media, as shown at block 424. This determination is made by checking the data matrix to see if a minimal pixel count or ink dot count (or other print marking count) will be achieved in printing the print job. If the minimum pixel count or ink dot count will not be met by printing the print job, the media protection module determines that there is not a minimally sufficient amount of marking agent that will be applied to the valuable media to conclude that the print job is legitimate for printing to valuable media, and the print job is canceled as discussed above regarding blocks 410 and 412. However, if the minimum pixel count or ink dot count will not be met by printing the print job, then the media protection module determines that there is a minimally sufficient amount of marking agent that will be applied to the valuable media to conclude that the print job is legitimate for printing to valuable media the print job, and the print job is printed as shown at block 406.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method for protecting valuable media comprising:
receiving a print job;
determining if target media for the print job is valuable media;
if the target media is valuable media, determining if an application program that originated the print job is authorized to print to valuable media; and
canceling the print job if the application program is not authorized to print to valuable media.

2. A method as recited in claim 1, wherein determining if target media is valuable media comprises:
parsing the print job to identify a media type of the target media; and
comparing the identified media type with a pre-determined list of valuable media types.

3. A method as recited in claim 1, wherein determining if an application program that originated the print job is authorized to print to valuable media comprises:
parsing the print job to identify an application type for the application program that originated the print job; and
comparing the identified application type with a pre-determined list of authorized applications.

4. A method as recited in claim 1, further comprising printing the print job if the target media is not valuable media.

5. A method as recited in claim 1, further comprising canceling the print job if the application program that originated the print job is not authorized to print to valuable media.

6. A method as recited in claim 5, further comprising notifying an administrative authority that a possible fraudulent attempt has been made to access valuable media.

7. A method as recited in claim 6, wherein the notifying comprises sending a notification, the notification including information selected from:
a user identification identifying a user who originated the print job;
a host device identification identifying a host device that originated the print job;
a printing device identification identifying a printing device where the print job was to print; and
a media type indicating the target media of the print job.

8. A method as recited in claim 1, wherein the application program is authorized to print to valuable media, the method further comprising:
determining if the print job is devoid of printable data; and
canceling the print job if it is devoid of printable data.

9. A method as recited in claim 8, wherein determining if the print job is devoid of printable data comprises an action selected from:
parsing the print job to identify printable data; and
comparing a file size of the print job to a known file size of an empty file originated by the application program.

10. A method as recited in claim 8, wherein the print job contains printable data, the method further comprising:
comparing the printable data in the print job to a minimally sufficient amount of printable data that corresponds with the application program that originated the print job; and
canceling the print job if the print job does not contain at least the minimally sufficient amount of printable data.

11. A method as recited in claim 10, wherein the print job contains at least the minimally sufficient amount of printable data, the method further comprising:
determining if a minimally sufficient amount of marking agent will be applied to the target media upon printing of the print job;
canceling the print job if the minimally sufficient amount of marking agent will not be applied to the target media upon printing of the print job; and
printing the print job if the minimally sufficient amount of marking agent will be applied to the target media upon printing of the print job.

12. A method as recited in claim 11, wherein determining if a minimally sufficient amount of marking agent will be applied to the target media upon printing of the print job comprises:
determining if any of the printable data will be printed in a white font; and
printing the print job if none of the printable data will be printed in a white font.

13. A method as recited in claim 12, wherein some of the printable data will be printed in a white font, the method further comprising:
determining if all of the printable data will be printed in a white font; and
canceling the print job if all of the printable data will be printed in a white font.

14. A method as recited in claim 13, wherein not all of the printable data will be printed in a white font, the method further comprising:
comparing a number of printing marks to be applied to the target media by the print job with a minimum number of printing marks that corresponds with the application program that originated the print job;
canceling the print job if the number of printing marks is less than the minimum number of printing marks; and
printing the print job if the number of printing marks is equal to or greater than the minimum number of printing marks.

15. A method as recited in claim 14, wherein the printing marks are selected from:
pixels; and
ink dots.

16. One or more computer-readable media having computer-executable instructions configured for:
receiving a print job;
evaluating the print job to determine if the print job is configured to print a blank document using valuable media; and
canceling the print job if it is configured to print a blank document using valuable media.

17. One or more computer-readable media as recited in claim 16, wherein the evaluating is selected from:
determining if the print job contains zero printable data;
determining if the print job contains a minimally sufficient amount of printable data;
determining if a minimally sufficient amount of marking agent will be applied to valuable media if the print job is printed.

18. One or more computer-readable media as recited in claim 17, wherein determining if a minimally sufficient amount of marking agent will be applied comprises:
determining if print data will be printed in a white font; and
determining if a minimum # of printing marks will be applied to the valuable media by printing the print job.

19. One or more computer-readable media as recited in claim 16 having further computer-executable instructions configured for:
determining if target media of the print job is valuable media; and
printing the print job if the target media is not valuable media.

20. One or more computer-readable media as recited in claim 16 having further computer-executable instructions configured for:
determining if an application program is authorized to print to valuable media; and
canceling the print job if the application program is not authorized to print to valuable media.

21. One or more computer-readable media as recited in claim 16, embodied in a device selected from:
a host computing device; and
a printing device.

22. A system comprising:
means for determining if a print job will print a blank document on valuable media;
means for canceling the print job if it will print a blank document on valuable media; and
means for sending a notification indicating a print job has been detected that is a possible attempt to fraudulently obtain access to blank valuable media.

23. A system as recited in claim 22, further comprising:
means for determining if target media of the print job is valuable media;
means for determining if an application program originating the print job is authorized to print to valuable media; and
means for canceling the print job if the target media is valuable media and the application program is not authorized to print to valuable media.

24. A system as recited in claim 22, wherein the means for determining if a print job will print a blank document on valuable media comprises:
means for determining an amount of printable data in the print job;
means for determining if a minimal amount of marking agent will be applied to the valuable media based on the printable data.

25. A device comprising:
a print file; and
a media protection module configured to evaluate the print file and determine if the print file has valuable media as target media, if the print file originated from an application program authorized to print to valuable media, and if the print file will print a blank document on valuable media.

26. A device as recited in claim 25, further comprising a data matrix having information indicating a list of valuable media, information indicating a list of authorized application programs, and a minimum number of printing marks associated with each authorized application program.

27. A device as recited in claim 25, wherein information in the data matrix, including the list of valuable media, the information indicating a list of authorized application programs, and the minimum number of printing marks associated with each authorized application program, are definable by a system administrator.

28. A device as recited in claim 25, further comprising the application program that originated the print file.

29. A device as recited in claim 25, further comprising a print engine configured to print the print file.
